(19) United States
(12) Patent Application Publication
(10) Pub. No.: US 2014/0103012 A1
(43) Pub. Date: Apr. 17, 2014

(54) VACUUM INTERRUPTER

(71) Applicant: Xi'an Jiaotong University, Xi'an (CN)

(72) Inventors: Zhiyuan LIU, Xi'an (CN); Yingsan GENG, Xi'an (CN); Jianhua WANG, Xi'an (CN); Sheng ZHANG, Xi'an (CN)

(73) Assignee: Xi'an Jiaotong University, Xi'an (CN)

(21) Appl. No.: 14/141,480

(22) Filed: Dec. 27, 2013

Related U.S. Application Data
(63) Continuation-in-part of application No. PCT/CN2012/073394, filed on Mar. 31, 2012.

(30) Foreign Application Priority Data
Jun. 30, 2011 (CN) 201110182291.7

(51) Int. Cl. H01H 1/02; H01H 33/02

(52) U.S. Cl. CPC H01H 1/0206; H01H 33/02
USPC 218/132; 218/123

(57) ABSTRACT

A vacuum interrupter, including a hollow housing, a plurality of end shields, a first shield, a second shield, a third shield, a first conductive rod, a second conductive rod, a static contact, and a moving contact. The hollow housing includes an inner wall. The end shields are disposed on an upper end and a lower end of the inner wall of the hollow housing. The hollow housing is double layered and made of ceramic. The first shield, the second shield, and the third shield are disposed on the inner wall between end shields on the upper end and end shields on the lower end of the inner wall in the form of an inward embedment or an outward embedment. The first conductive rod and the second conductive rod are vertically inserted into the hollow housing from a top and a bottom of the hollow housing, respectively.

### CROSS-REFERENCE TO RELATED APPLICATIONS

This application is a continuation-in-part of International Patent Application No. PCT/CN2012/073394 with an international filing date of Mar. 31, 2012, designating the United States, now pending, and further claims priority benefits to Chinese Patent Application No. 201110182291.7 filed Jun. 30, 2011. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a single-break vacuum interrupter.

2. Description of the Related Art

Conventional high voltage single-break vacuum interrupters include a housing, a shield system, and a contact assembly. The housing is generally made of glass or ceramic. The shield system operates to prevent metal vapor from condensing on the insulating housing whereby ensuring the insulating property thereof. The contact assembly includes a contact, a conductive rod, and a conductive coil. The current circulates in the conductive rod and the conductive coil and passes on to another contact assembly via the contact. For a high voltage vacuum interrupter, a contact assembly capable of generating a axial magnetic field is generally employed to control the vacuum arc plasma. The coil of the contact assembly can generate the axial magnetic field to control the arcing energy whereby improving the breaking capacity. However, the stronger the axial magnetic field is, the larger the resistance of the coil loop is, and thus the more the produced heat is, which results in a low rated current carrying capacity. Furthermore, conventional vacuum interrupters employ a four-segmented porcelain housing, but for a large-sized porcelain housing, four segments are not practicable. And due to the decentralization of the diameter and concentricity of the four-segmented porcelain housing, the four-segmented porcelain housing is very difficult to assemble.

### SUMMARY OF THE INVENTION

In view of the above-described problems, it is one objective of the invention to provide a single-break vacuum interrupter that has a high rated current carrying capacity, high breaking capacity, high insulation capability, and convenient assembly.

To achieve the above objective, in accordance with one embodiment of the invention, there is provided a vacuum interrupter, comprising a hollow housing, a plurality of end shields, a first shield, a second shield, a third shield, a first conductive rod, a second conductive rod, a static contact, and a dynamic contact. The hollow housing comprises an inner wall.

The end shields are disposed on an upper end and a lower end of the inner wall of the hollow housing. The hollow housing is double layered and made of ceramic. The first shield, the second shield, and the third shield are disposed on the inner wall between end shields on the upper end and end shields on the lower end of the inner wall in the form of an inward embedment or an outward embedment. The first conductive rod and the second conductive rod are vertically inserted into the hollow housing from a top and a bottom of the hollow housing, respectively. The static contact and the moving contact are disposed on two ends of the first conductive rod and the second conductive rod inside the hollow housing, respectively, and the static contact and the moving contact are opposite to each other vertically with spacing. A first back shield is disposed on the first conductive rod over the static contact, and a second back shield is disposed on the second conductive rod below the moving contact. The static contact and the moving contact comprise hollow coils respectively encircling the two ends of the first conductive rod and the second conductive rod inside the hollow housing; one end of each of the hollow coils is connected to an arcing contact by welding; each end of the first conductive rod and the second conductive rod inside the hollow coils is provided with a first main contact, respectively. The arcing contact is provided with a second main contact which is opposite to the first main contact.

In a class of this embodiment, the first main contact and the second main contact are made of resistant welding material, and the arcing contact is made of arc-resistant material.

In a class of this embodiment, the first main contact and the second main contact are made of copper-tungsten material, and the arcing contact is made of copper-chrome material.

In a class of this embodiment, the hollow coils are capable of producing cup type axial magnetic field, and the coils are ⅓ turn, ⅔ turn, ¼ turn, ½ turn, or single-turn coils.

In a class of this embodiment, the first main contact, the second main contact, and the arcing contact are designed to have an arc profile whereby generating electric field intensity no more than flat field intensity.

Advantages of the invention are summarized as follows. The first conductive rod and the second conductive rod are vertically inserted into the hollow housing from the top and the bottom of the hollow housing, respectively. The static contact and the moving contact are disposed on two ends of the first conductive rod and the second conductive rod inside the hollow housing, respectively, and the static contact and the moving contact are opposite to each other vertically with spacing. Thus, the current circulates along the first conductive rod, the first main contact of the static contact, the arcing contact of the static contact, the arcing contact of the moving contact, the second main contact of the moving contact, and the second conductive rod in sequence. Optionally, the current can circulate along the first conductive rod, the hollow coil of the static contact, the arcing contact of the static contact, the arcing contact of the moving contact, the hollow coil of the moving contact, and the second conductive rod in sequence. Thus, the vacuum interrupter has dual functions of breaking short-circuit current and carrying rated current. The first conductive rod, the second conductive rod, the first main contact, and the second main contact cooperate to carry high rated current. The first conductive rod, the second conductive rod, the hollow coils, and the arcing contacts cooperate to break short-circuit current. Therefore, both the breaking capacity and the current-carrying capacity of the vacuum interrupter are improved without increasing the size of the contact. The vacuum interrupter employs the double layered hollow housing which is easy to assemble, so that the conventional four-segmented porcelain housing is substituted, and the decentralization of the diameter and concentricity of the four-segmented porcelain housing is no need to consider. The ceramic has good sealing effect with the metal materials, which can prevent the air leakage, thereby achieving high insulating properties. That the first shield, the second shield, and the third shield are disposed in the form of an inward embedment or an outward embedment further enhances the insulating properties. The first main contact and the second main contact are made of copper-tungsten material, and the arcing contact is made of copper-chrome material, which enhances the breaking capacity.

### BRIEF DESCRIPTION OF THE DRAWINGS

FIG. 1 is a schematic diagram of a vacuum interrupter of which a first shield, a second shield, and a third shield are in the form of an inward embedment in accordance with one embodiment of the invention; and

FIG. 2 is a schematic diagram of a vacuum interrupter of which a first shield, a second shield, and a third shield are in the form of an outward embedment in accordance with one embodiment of the invention.

### DETAILED DESCRIPTION OF THE EMBODIMENTS

For further illustrating the invention, experiments detailing a vacuum interrupter are described below. It should be noted that the following examples are intended to describe and not to limit the invention.

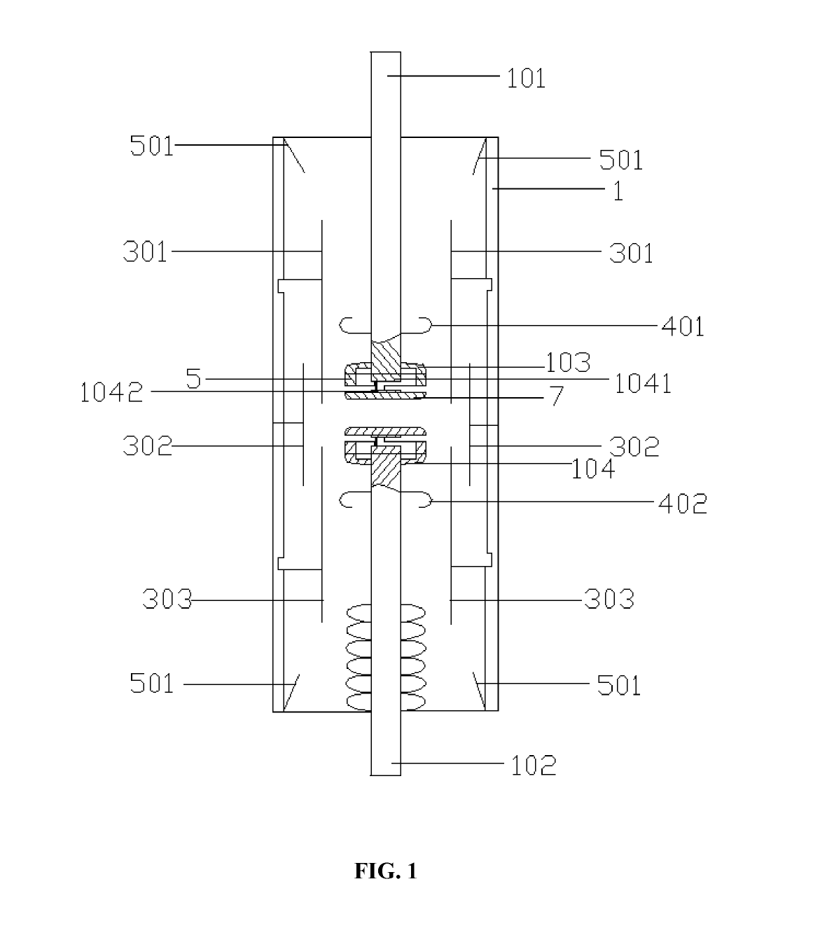

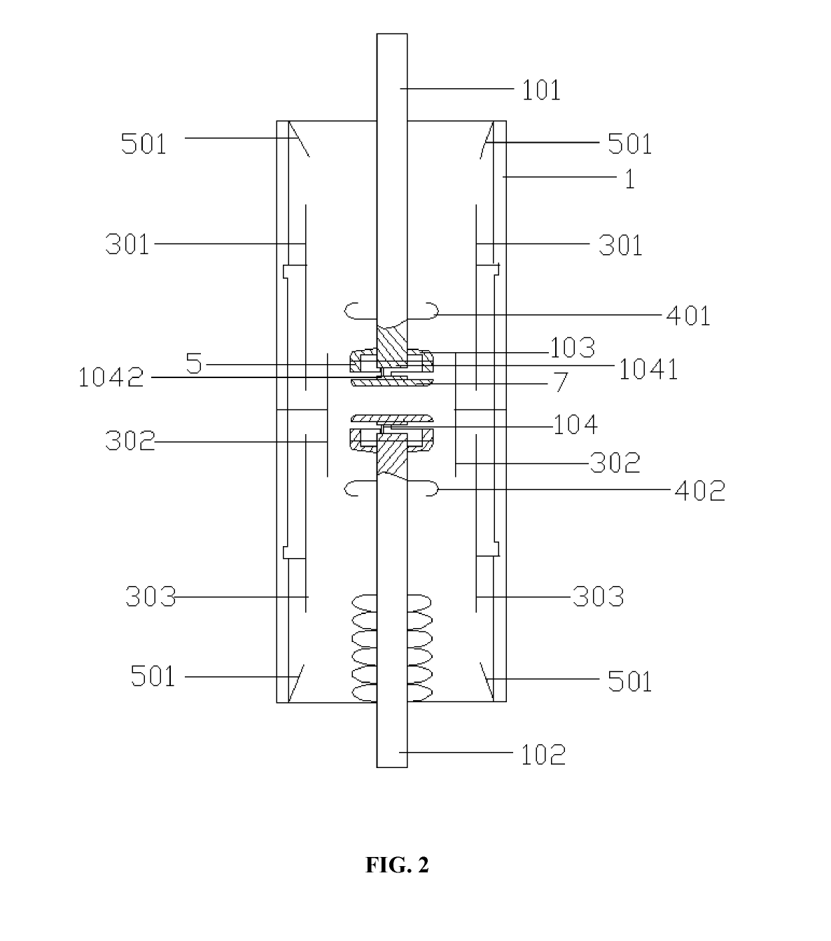

As shown in FIG. 1 and FIG. 2, a vacuum interrupter comprises: a hollow housing 1, the hollow housing comprising an inner wall; a plurality of end shields 501; a first shield 301; a second shield 302; a third shield 303; a first conductive rod 101; a second conductive rod 102; a static contact 103. the end shields 501 are disposed on an upper end and a lower end of the inner wall of the hollow housing; the hollow housing 1 is double layered and made of ceramic; the first shield 301, the second shield 302, and the third shield 303 are disposed on the inner wall between end shields on the upper end and end shields on the lower end of the inner wall in the form of an inward embedment or an outward embedment; the first conductive rod 101 and the second conductive rod 102 are vertically inserted into the hollow housing from a top and a bottom of the hollow housing, respectively; the static contact 103 and the moving contact 104 are disposed on two ends of the first conductive rod 101 and the second conductive rod 102 inside the hollow housing 1, respectively, and the static contact and the moving contact are opposite to each other vertically with an spacing; a first back shield 401 is disposed on the first conductive rod 101 over the static contact, and a second back shield 402 is disposed on the second conductive rod 102 below the moving contact; the static contact and the moving contact comprise hollow coils 5 respectively encircling the two ends of the first conductive rod 101 and the second conductive rod 102 inside the hollow housing 1; one end of each of the hollow coils is connected to an arcing contact 7 by welding; each end of the first conductive rod 101 and the second conductive rod 102 inside the hollow coils is provided with a first main contact 1041, respectively; and the arcing contact 7 is provided with a second main contact 1042 which is opposite to the first main contact 1041.

The first main contact and the second main contact are made of copper-tungsten material, and the arcing contact is made of copper-chrome material. The hollow coils 5 are capable of producing cup type axial magnetic field, and the coils are ⅓ turn, ⅔ turn, ¼ turn, ½ turn, or single-turn coils. The first main contact 1041, the second main contact 1042, and the arcing contact 7 are designed to have an arc profile whereby generating electric field intensity no more than flat field intensity.

The working principle of the vacuum interrupter is described below. When the single-break vacuum interrupter is switching on, the first main contact 1041 at the end of the first conductive rod 101 and the second main contact 1042 on the arcing contact 7 are electrically connected under the pressure imposed thereon. Thus, a large amount of current circulates along the first main contact 1041, the second main contact 1042, and the arcing contact 7. When the single-break vacuum interrupter is switched off, the pressure imposed on the first main contact 1041 and the second main contact 1042 disappear immediately. Under the welding force of the arcing contact of the moving contact 104 and the arcing contact of the static contact 103, the first main contact 1041 and the second main contact 1042 detaches to form a break. Thus, the current circulates along the arcing contact 7, the coils 5, and the first conductive rod 101. Thereafter, under the pulling force of an actuating mechanism, the current is cut successfully.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A vacuum interrupter, comprising:
a) a hollow housing (1), the hollow housing comprising an inner wall;
b) a plurality of end shields (501);
c) a first shield (301);
d) a second shield (302);
e) a third shield (303);
f) a first conductive rod (101);
g) a second conductive rod (102);
h) a static contact (103);
i) a dynamic contact (104);
wherein
the end shields (501) are disposed on an upper end and a lower end of the inner wall of the hollow housing;
the hollow housing (1) is double layered and made of ceramics material;
the first shield (301), the second shield (302), and the third shield (303) are disposed on the inner wall between end shields on the upper end and end shields on the lower end of the inner wall in the form of an inward embedment or an outward embedment;
the first conductive rod (101) and the second conductive rod (102) are vertically inserted into the hollow housing from a top and a bottom of the hollow housing, respectively;
the static contact (103) and the moving contact (104) are disposed on two ends of the first conductive rod (101) and the second conductive rod (102) inside the hollow housing (1), respectively, and the static contact and the moving contact are opposite to each other vertically with spacing;
a first back shield (401) is disposed on the first conductive rod (101) over the static contact, and a second back shield (402) is disposed on the second conductive rod (102) below the moving contact;
the static contact and the moving contact comprise hollow coils (5) respectively encircling the two ends of the first conductive rod (101) and the second conductive rod (102) inside the hollow housing (1);
one end of each of the hollow coils is connected to an arcing contact (7) by welding;
each end of the first conductive rod (101) and the second conductive rod (102) inside the hollow coils is provided with a first main contact (1041), respectively; and
the arcing contact (7) is provided with a second main contact (1042 which is opposite to the first main contact (1041).

2. The vacuum interrupter of claim 1, wherein the first main contact and the second main contact are made of resistant welding material, and the arcing contact is made of arc-resistant material.

3. The vacuum interrupter of claim 2, wherein the first main contact and the second main contact are made of copper-tungsten material, and the arcing contact is made of copper-chrome material.

4. The vacuum interrupter of claim 1, wherein the hollow coils (5) are capable of producing cup type axial magnetic field, and the coils are ⅓ turn, ⅔ turn, ¼ turn, ½ turn, or single-turn coils.

5. The vacuum interrupter of claim 2, wherein the hollow coils (5) are capable of producing cup type axial magnetic field, and the coils are ⅓ turn, ⅔ turn, ¼ turn, ½ turn, or single-turn coils.

6. The vacuum interrupter of claim 1, wherein the first main contact (1041), the second main contact (1042), and the arcing contact (7) are designed to have an arc profile whereby generating electric field intensity no more than flat field intensity.

7. The vacuum interrupter of claim 2, wherein the first main contact (1041), the second main contact (1042), and the arcing contact (7) are designed to have an arc profile whereby generating electric field intensity no more than flat field intensity.
